(19) United States
(12) Patent Application Publication
(10) Pub. No.: US 2009/0313657 A1
(43) Pub. Date: Dec. 17, 2009

(54) System and Method for Scheduling a Remote Recording

(75) Inventors: James Austin Britt, Manor, TX (US); Adam Klein, Cedar Park, TX (US); Joshua J. Fox, Austin, TX (US); Tara Hines, McKinney, TX (US)

Correspondence Address: AT&T Legal Department - LNA;Attn: Patent Docketing, Room 2A- 207, One AT & T Way, Bedminster, NJ, 07921, US

(73) Assignee: AT&T INTELLECTUAL PROPERTY I, L.P., Reno, NV (US)

(21) Appl. No.: 12/136,961

(22) Filed: Jun. 11, 2008

(51) Int. Cl. G06F 3/01; H04N 7/173

(52) U.S. Cl. 725/51; 725/97

(57) ABSTRACT

A method for scheduling a remote recording includes receiving a selection by a user of a web interface element associated with an Internet protocol television program to be broadcast by a provider. Additionally, determining that the user does not subscribe to the provider of the Internet protocol television program, providing the user with an ability to subscribe to the provider; and scheduling the television program to record.

### FIELD OF THE DISCLOSURE

The present disclosure generally relates to communications networks, and more particularly relates to systems and methods for scheduling remote recordings.

### BACKGROUND

Computer users often encounter references to entertainment content such as news stories, blog entries, and the like while browsing web pages. For example, the user might read a news story about a television show or view an advertisement for the television show. If the user is interested in recording that television show, they typically have to manually program their digital video recorder (DVR). Alternatively, if the user has a DVR offering remote Internet access capability, the user can navigate to a remote access web application to schedule the recording.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an Internet Protocol Television (IPTV) network;

FIG. 2 is an exemplary screen shot of a webpage;

FIG. 3 is an exemplary screen shot of a sign-in webpage for a remote set-top box access website;

FIG. 4 is an exemplary screen shot of a remote scheduling menu;

FIG. 5 is a flow diagram of a method for scheduling the recording of a television program through a web interface element;

FIG. 6 is a flow diagram of a method for subscribing to an IPTV service;

FIG. 7 is a flow diagram of an alternative method for scheduling the recording of a television program through a web interface element; and

FIG. 8 is a block diagram of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

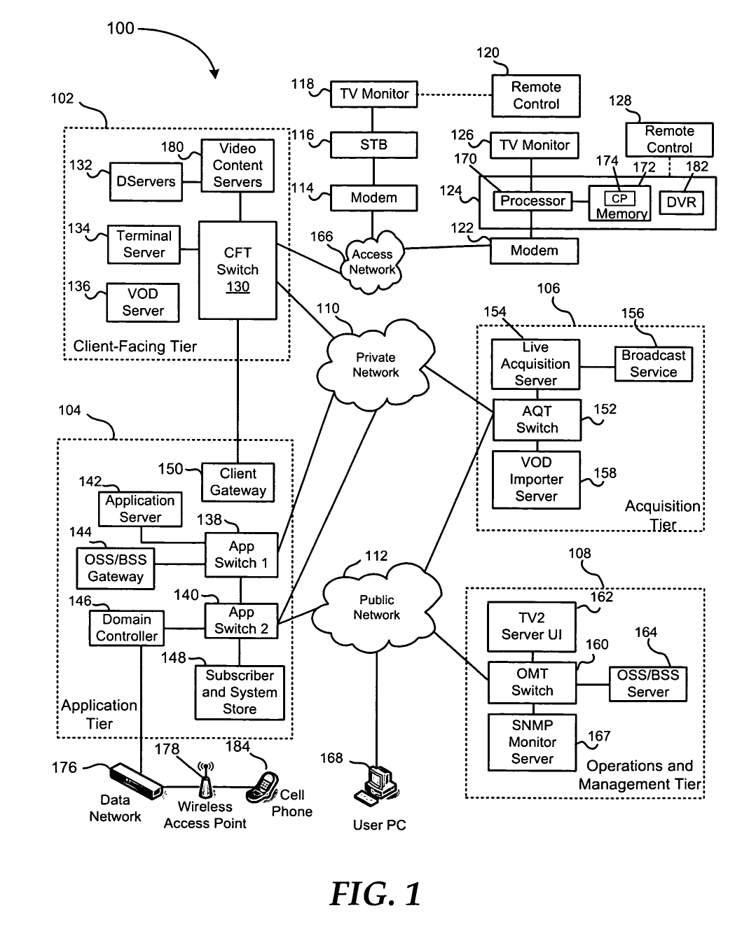

FIG. 1 shows an Internet protocol television (IPTV) system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to the public network 112 such as the Internet. The acquisition tier 106 can also be coupled to the private network 110 and to the public network 112. Moreover, the operations and management tier 108 can be coupled to the public network 112.

The various tiers 102, 104, 106 and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an IPTV network. In an illustrative embodiment, modems such as a first modem 114 and a second modem 122 can be coupled to the private access network 166. The client-facing tier 102 can communicate with a first representative set-top box device 116 via the first modem 114 and with a second representative set-top box device 124 via the second modem 122. The client-facing tier 102 can communicate with a large number of set-top boxes over a wide geographic area, such as a regional area, a metropolitan area, a viewing area, or any other suitable geographic area that can be supported by networking the client-facing tier 102 to numerous set-top box devices. In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received from the private access network 166 via an IPTV software platform such as Microsoft® TV IPTV Edition.

The first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display device 118 or 126 to which it is coupled. The set-top box devices 116 and 124 thus may include tuners that receive and decode television programming information for transmission to the display devices 118 and 126. Further, the set-top box devices 116 and 124 can include a set-top box processor 170 and a set-top box memory device 172 that is accessible to the set-top box processor. In a particular embodiment, the set-top box devices 116 and 124 can also communicate commands received from the remote controls 120 and 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server and other devices with a common connection point to the private network 110. In a particular embodiment, the CFT switch 130 can also be coupled to a video-on-demand (VOD) server 136.

The application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 via the private access network 166, so the set-top box devices 116 and 124 can provide functions such as display, messaging, processing of IPTV data and VOD material. In a particular embodiment, the OSS/BSS gateway 144 includes operation systems and support (OSS) data, as well as billing systems and support (BSS) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices, from accessing the private network 110 by denying access to these devices beyond the private access network 166.

For example, when the set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, such as because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

The operations and management tier 108 can include an operations and management tier (OMT) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (SNMP) monitor 167 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 in turn can transmit the television content to the AQT switch 152 and the AQT switch can transmit the television content to the CFT switch 130 via the private network 110. Further, the television content can be encoded at the D-servers 132, and the CFT switch 130 can communicate the television content to the modems 114 and 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the set-top box device 116 or 124, the request can be transmitted over the private access network 166 to the VOD server 136 via the CFT switch 130. Upon receiving such a request, the VOD server 136 can retrieve requested VOD content and transmit the content to the set-top box device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer (PC) 168 coupled to the public network 112.

The domain controller 146 communicates with the public network 112 via the second APP switch 140. Additionally, the domain controller 146 can communicate via the public network 112 with the PC 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices such as a cellular telephone 184.

In a particular embodiment, the set-top box devices can include a set-top box computer program 174 that is embedded within the set-top box memory device 172. The set-top box computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124 by associating the user account with an IP address of the second set-top box device, with data relating to one or more twisted pairs connected with the second set-top box device, with data related to one or more fiber optic cables connected with the second set-top box device, with an alphanumeric identifier of the second set-top box device, with any other data that is suitable for associating the second set-top box device with a user account, or with any combination of these.

The set-top box computer program 174 can contain instructions to receive many types of user preferences from the domain controller 146 via the access network 166. For example, the set-top box computer program 174 can include instructions to receive a request to record at least one television program at a video content storage module such as a digital video recorder (DVR) 182 within the second set-top box device 124. In this example embodiment, the set-top box computer program 174 can include instructions to transmit the request to the DVR 182, where the television program(s) are recorded. In an illustrative embodiment, the set-top box computer program 174 can include instructions to receive from the DVR 182 a recording status with respect to one or more of the television programs and to transmit at least one message regarding the status to a wireless device, such as the cellular telephone 184. The message can be received at the CFT switch 130, for instance, and communicated to the domain controller 146 across the private network 110 via the second APP switch 140. Further, the domain controller 146 can transmit the message to the wireless data network 176, directly or via the public network 112, and on to the wireless network access point 178. The message can then be transmitted to the cellular telephone 184. In an illustrative embodiment, the status can be sent via a wireless access protocol (WAP).

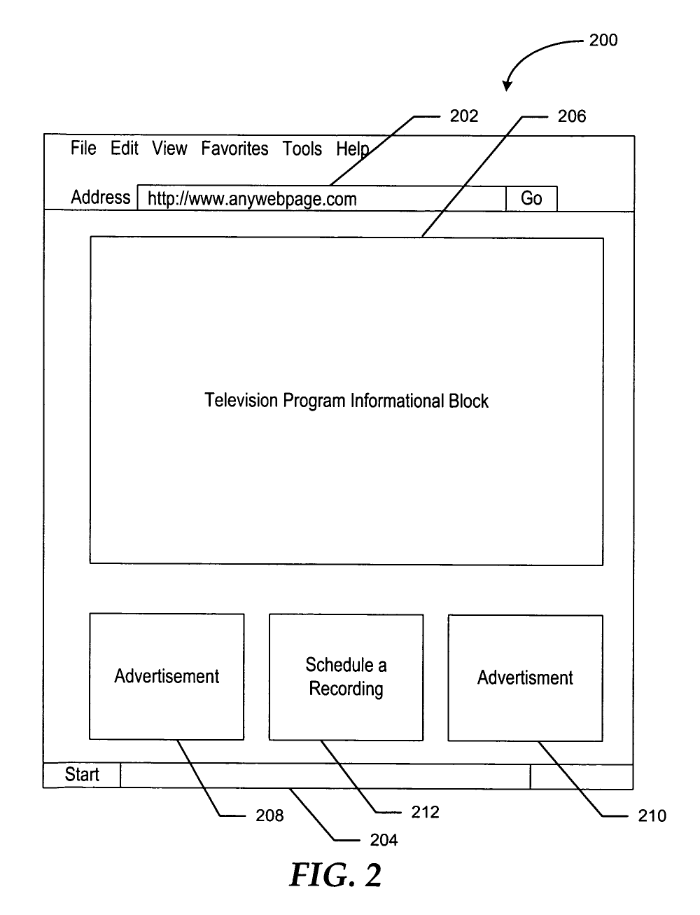

FIG. 2 shows an exemplary screen shot of a webpage 200 that a user may encounter while accessing the public network 112 with the PC 168. The webpage 200 includes an address line 202, a tool bar 204, a television program informational block 206, advertisements 208 and 210, and a web interface element 212. As used herein, television program refers to any type of video information that can be provided to a user, including series episodes, movies, video clips, music videos, commercials, or the like. The television program information block 206 can display pictures, video and text related to an individual television program or a series of television programs. The webpage 200 can be a television network webpage promoting one or more programs that it broadcasts, a blogger's webpage discussing those programs, and the like. The entity that creates, maintains, serves, or owns the webpage 200 can provide others with the ability to schedule a recording of various programming by posting the web interface element 212 on the webpage.

The web interface element 212 can include meta-data to identify a specific television program, an entire television series, a VOD, and the like. The web interface element 212 also can provide access to a web portal of the domain controller 146. The web portal can be a remote set-top box access website that allows the user to control different features on the set-top box devices 116 and 124. The different features can include setting a television program to be recorded, setting a reminder for a television program, scheduling a VOD movie for download, and the like. These features can be saved on the remote set-top box access website and then sent to the set-top box computer program 174 of the second set-top box device 124 to be executed.

Upon the user selecting the web interface element 212, the OSS/BSS server 164 of the IPTV system 100 can determine whether the user has an account with the IPTV system. If the user has an account, the OSS/BSS server 164 can further determine whether the user is currently logged into the remote set-top box access website or into an email account that is associated with a user account of the IPTV system. If the user is currently logged onto a user account, then the web interface element 212 can automatically set the associated television program to record on the set-top box devices 116 or 124 through a backend server of the IPTV system 100. Additionally, the web interface element 212 can list the television program on a scheduled recordings menu of the remote set-top box access website. The backend server can be the VOD servers 136, the live acquisition server 154, the video content servers 180, and the like of the IPTV system 100. The backend servers can store the titles of television programs that can be recorded by the DVR 182 of the second set-top box device 124 and the titles of VOD movies that can be downloaded by the second set-top box device. Information about the television programs that are stored on the backend servers can be compared to the television program information stored in the web interface element 212 to determine the television program that the user wants to record.

If the user is not currently logged in, then the web interface element 212 also can directly or indirectly link to a sign-in webpage for the remote set-top box access website. Upon signing-in, the user is able to set the television program to record on the set-top box devices 116 or 124. However authenticated, the user can access the remote set-top box access website to record the television program associated with the web interface element 212 as a recurring event on the set-top box devices 116 or 124. For example, if the television program is a part of a television series that comes on at the same time every week, then the user can set future recordings of the television program for every week that it is broadcast or propagated.

If the OSS/BSS server 164 determines that the user that selected the web interface element 212 does not have an account associated with IPTV service of the IPTV system 100, the web interface element 212 can direct the user to a website that can allow the user to subscribe to IPTV service through the IPTV system. When the user selects the web interface element 212, the system thus can either automatically set the associated television program to record on the set-top box device 116 or 124, provide access to the remote set-top box access website, or provide access to a website that will allow the user to subscribe to the IPTV service.

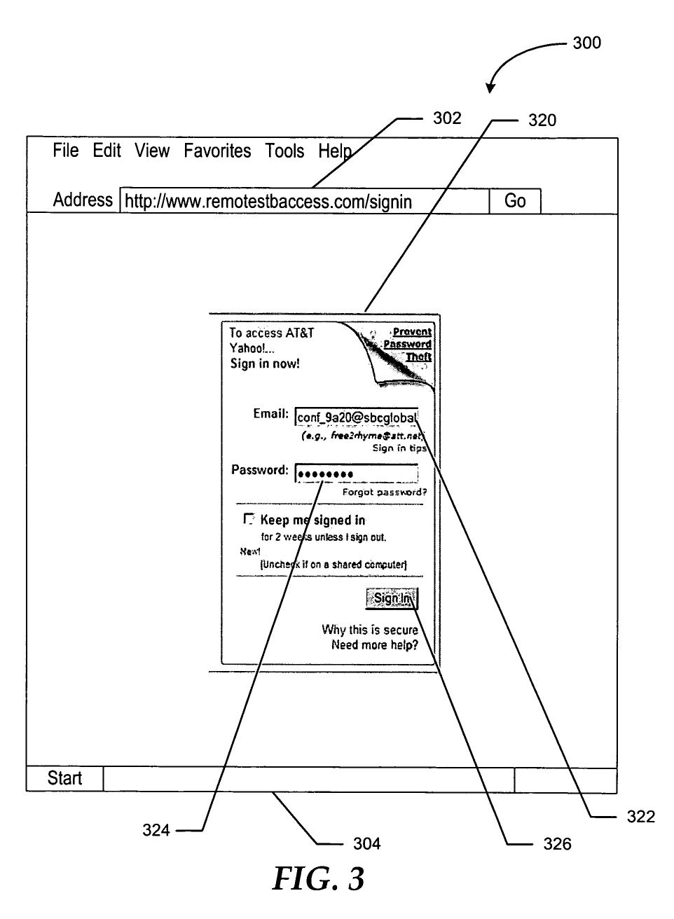

FIG. 3 is an exemplary screen shot of a sign-in webpage 300 including an address line 302, a tool bar 304, a sign-in box 320, an email entry block 322, a password entry block 324, and a sign-in button 326. Upon selecting the web interface element 212 of FIG. 2, the user may be presented with the sign-in webpage 300 having a URL such as remotestbaccess.com/signin as shown in the address line 302. The webpage 300 displays the sign-in box 320 including the email entry block 322 into which the user can enter his or her email address. Also, the user can enter a password associated with the user account in the password entry block 324. Upon entering both the email address and password, the user can select the sign-in button 326 to request access to a set-top box remote access website. The OSS/BSS server 164 of FIG. 1 can authenticate the user to the set-top box remote access webpage by verifying that the email address entered into the email entry block 322 and the password entered into the password entry block 324 match a user account of the IPTV system 100.

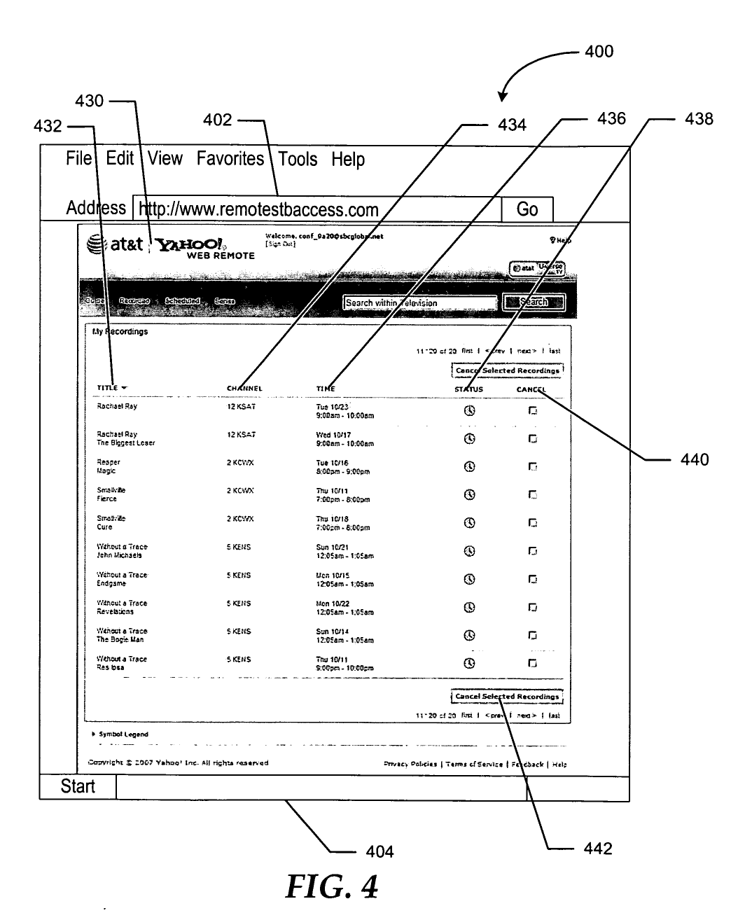

FIG. 4 is an exemplary screen shot of a set-top box remote access webpage 400 including an address line 402, a tool bar 404, and a remote scheduling menu 430. Upon signing into the remote set-top box access website, the user can view the set-top box remote access webpage 400, with a URL such as remotestbaccess.com as shown in the address line 402, displaying the remote scheduling menu 430. The remote scheduling menu 430 includes a title column 432, a channel column 434, a time column 436, a status column 438, a cancel column 440, and a cancel selected recordings button 442. The title column 432 can display the series title along with an individual television program title of a television program that is scheduled to record. The channel column 434 can display the channel number and the channel name of a local or national television broadcast channel that is going to provide the television program. The time column 436 can display both a date and a time of day that the television program is set to record. The status column 438 can display whether the television program is waiting to be recorded or if it has already been recorded. The cancel column 440 can enable the user to select one or more scheduled recordings to cancel. After selecting one or more scheduled recordings, the user can select the cancel selected recordings button 442 to remove the selected television program or programs from the remote scheduling menu 430.

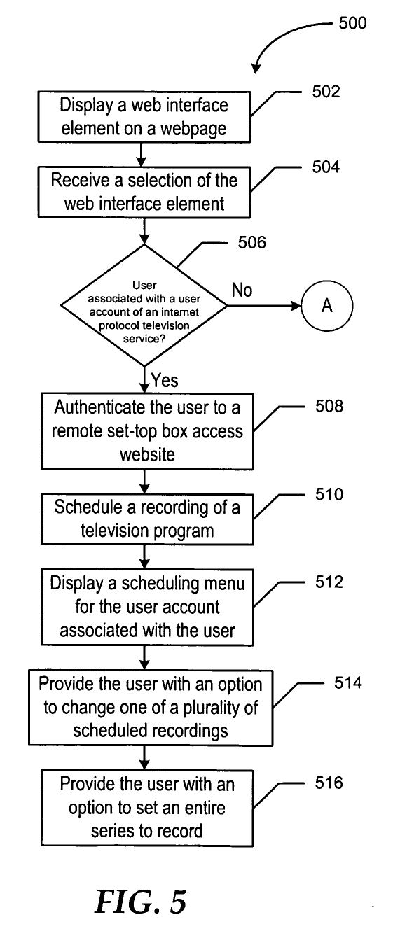

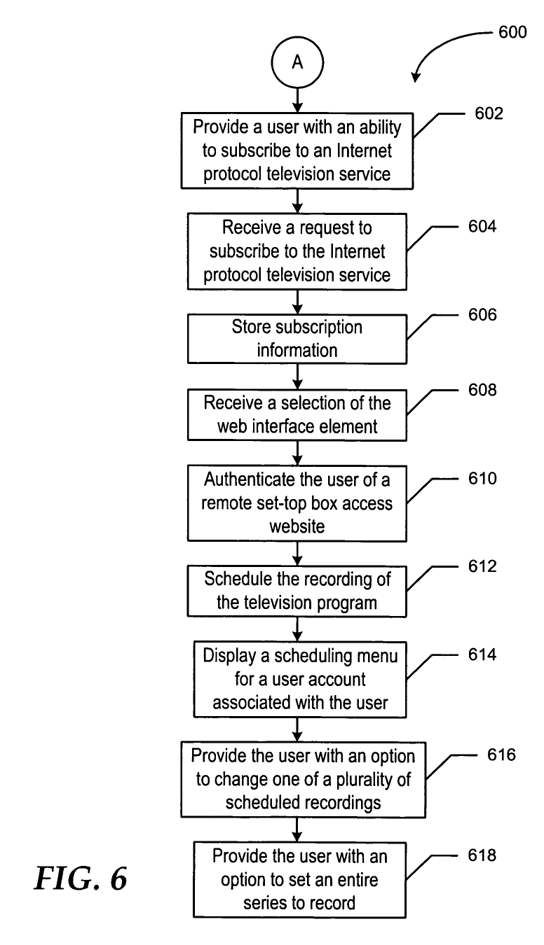

FIG. 5 is a flow diagram of a method 500 for scheduling the recording of a television program through a web interface element. At block 502, a web interface element is displayed on a webpage. A selection of the web interface element is received at block 504. At block 506, a determination is made whether a user associated with a user account of an IPTV service selected the web interface element. If the user that selects the web interface element does not have a user account, then the flow diagram continues at block A of FIG. 6. If the web interface element is selected by a user of the IPTV service, then the user is authenticated to a remote set-top box access website at block 508. At block 510, a recording of a television program is scheduled. The scheduling of the television program can occur automatically without the need for any additional input from the user. A scheduling menu for the user account associated with the user is displayed at block 512. At block 514, the user is provided with an option to change one of a plurality of scheduled recordings. The user is provided with an option to set an entire series associated with the television program to record at block 516.

FIG. 6 is a flow diagram of a method 600 for subscribing to an IPTV service. At block 602, the user is provided with an ability to subscribe to IPTV service. Indication of an intent to subscribe to the IPTV service is received at block 604. At block 606, information associated with the subscription to the IPTV service is stored. A selection of the web interface element is received at block 608. At block 610, the user of a remote set-top box access website is authenticated. The recording of the television program is scheduled at block 612. At block 614, a scheduling menu for a user account associated with the user is displayed. The user is provided with an option to change one of a plurality of scheduled recordings at block 616. At block 618, the user is provided with an option to set an entire series to record. The series is associated with the selected television program.

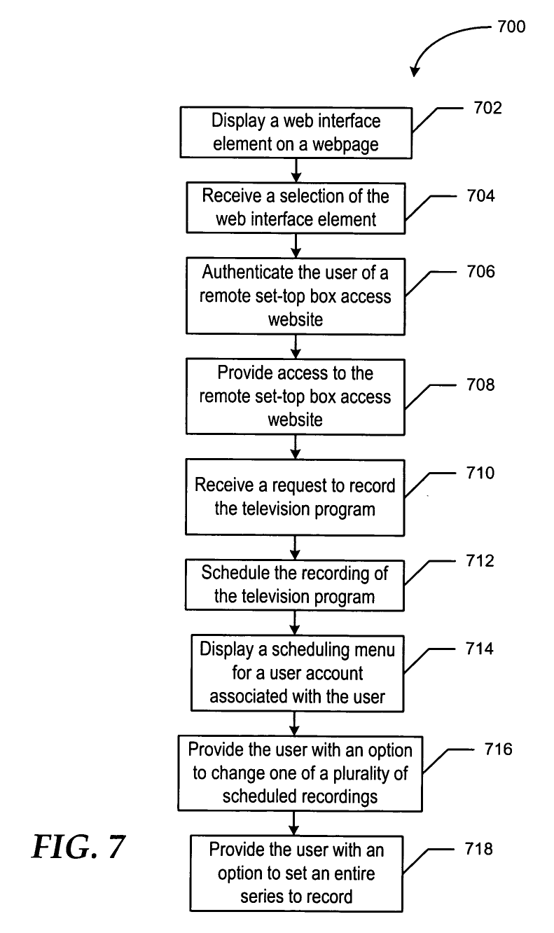

FIG. 7 is a flow diagram of an alternative method 700 for scheduling the recording of a television program through a web interface element. At block 702, a web interface element is displayed on a webpage. A selection of the web interface element is received at block 704. At block 706, the user of a remote set-top box access website is authenticated. Access to the remote set-top box website is provided at block 708. At block 710, a request to record the television program is received. The recording of the television program is scheduled at block 712. A scheduling menu for a user account associated with the user is displayed at block 714. At block 716, the user is provided with an option to change one of a plurality of scheduled recordings. The user is provided with an option to set an entire series to record at block 718.

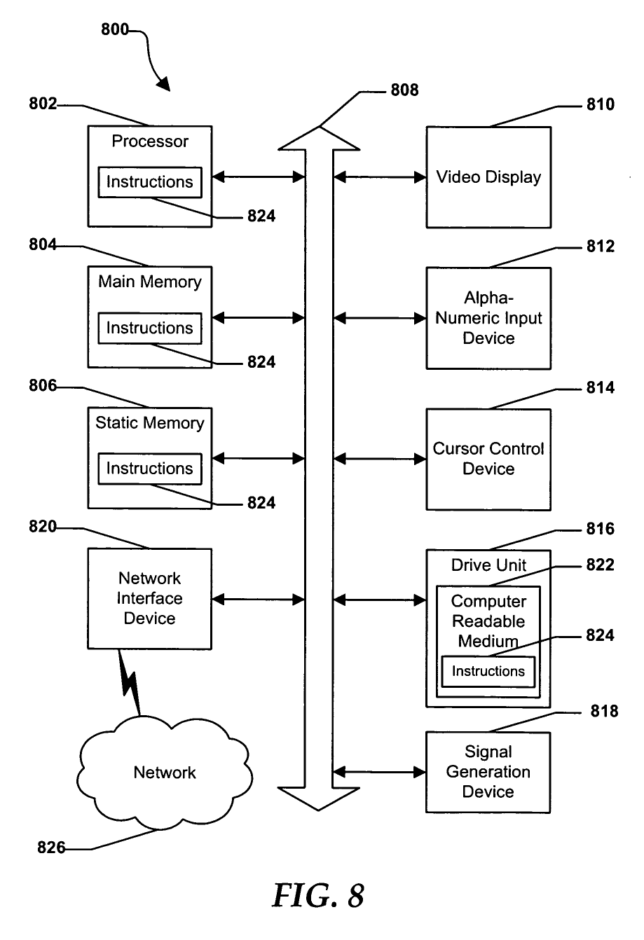

FIG. 8 shows an illustrative embodiment of a general computer system 800 in accordance with at least one embodiment of the present disclosure. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

The computer system 800 may include a processor 802, e.g., a central processing unit (CPU), a graphics processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media. The network interface device 820 can provide connectivity to a network 826, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. § 1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method comprising:
receiving a selection by a user of a web interface element associated with an Internet protocol television program to be broadcast by a provider;
determining that the user does not subscribe to the provider of the Internet protocol television program;
providing the user with an ability to subscribe to the provider; and
scheduling the television program to record.

2. The method of claim 1 further comprising:
displaying a scheduling menu for a user account associated with the user; and
providing the user with an option to change one of a plurality of scheduled recordings.

3. The method of claim 1 further comprising:
providing the user with an option to record an entire series associated with the television program.

4. The method of claim 1 wherein scheduling the television program to record further comprises setting a backend server to record the television program.

5. The method of claim 1 wherein the television program is scheduled to record on a set-top box associated with the user.

6. The method of claim 1 wherein the web interface element is displayed on a website promoting the Internet protocol television program.

7. A method comprising:
receiving a request over the Internet from a user to record a television program to be broadcast by a provider;
authenticating the user as a subscriber of the provider; and
scheduling the television program to record.

8. The method of claim 7 further comprising:
displaying a scheduling menu for a user account associated with the user; and
providing the user with an option to change one of a plurality of scheduled recordings.

9. The method of claim 7 further comprising:
providing the user with an option to record an entire series associated with the television program.

10. The method of claim 7 wherein scheduling the television program to record further comprises setting a backend server to record the television program.

11. The method of claim 7 wherein the television program is scheduled to record on a set-top box associated with the user.

12. The method of claim 7 wherein the television program is an Internet protocol television program.

13. A method comprising:
receiving a selection by a user of a web interface element associated with a television program to be broadcast by a provider;
authenticating the user as a subscriber of the provider; and
displaying a scheduling menu for an account associated with the user.

14. The method of claim 13 further comprising scheduling the television program to record.

15. The method of claim 14 wherein scheduling the television program to record further comprises setting a backend server to record the television program.

16. The method of claim 13 further comprising:
providing the user with an option to change one of a plurality of scheduled recordings.

17. The method of claim 13 further comprising:
providing the user with an option to record an entire series associated with the television program.

18. The method of claim 13 wherein the television program is an Internet protocol television program.

19. A method comprising:
receiving a selection by a user of a web interface element associated with a television program to be broadcast by a provider;
providing access to a login page;
authenticating the user as a subscriber of the provider; and
scheduling the television program to record on a set-top box associated with the user.

20. The method of claim 19 further comprising:
displaying a scheduling menu for a user account associated with the user; and
providing the user with an option to change one of a plurality of scheduled recordings.

21. The method of claim 19 wherein the web interface element is displayed on a website promoting the television program.

22. The method of claim 19 further comprising:
providing the user with an option to record an entire series associated with the television program.

23. The method of claim 19 wherein authenticating the user includes receiving a username and password.

24. The method of claim 19 wherein scheduling the television program to record further comprises setting a backend server to record the television program.

25. The method of claim 19 wherein the television program is an Internet protocol television program.
